(19) United States
(12) Patent Application Publication
(10) Pub. No.: US 2011/0297318 A1
(43) Pub. Date: Dec. 8, 2011

(54) METAL-TO-POLYMER BONDING USING AN ADHESIVE BASED ON EPOXIDES

(75) Inventors: Emilie Barriau, Duesseldorf (DE); David Farrell, Dublin (IE); Dennis Bankmann, Duesseldorf (DE); Michael Doherty, Donegal (IE); Ciaran B. McArdle, Dublin (IE); Martin Renkel, Duesseldorf (DE); Sven Wucherpfennig, Dormagen (DE); Siegfried Kopannia, Krefeld (DE)

(73) Assignees: Loctite (R&D) Limited, Dublin (IE); Henkel AG & Co. KGaA, Duesseldorf (DE)

(21) Appl. No.: 13/211,908

(22) Filed: Aug. 17, 2011

Related U.S. Application Data
(63) Continuation of application No. PCT/EP2010/051611, filed on Feb. 10, 2010.
(60) Provisional application No. 61/153,172, filed on Feb. 17, 2009.

(51) Int. Cl. B32B 37/12

(52) U.S. Cl. 156/330

(57) ABSTRACT

A process of bonding a metal substrate to a non-halogenated polymer, especially of bonding a polyolefin overcoat to a metallic tube or pipe, using an epoxy-based adhesive which comprises at least one salt of a metal ion M in an oxidation state of n which has a standard reduction potential E⁰_{M} more positive than the standard reduction potential of the surface of the metal substrate; an object comprising a metal substrate and a non-halogenated polymer bonded together by this process; a tube or pipe made of a metal substrate onto which a layer of a non-halogenated polymer is bonded by a cured epoxy-based adhesive.

The present invention lies in the field of bonding metals to non-halogenated polymers by using an epoxy-based adhesive. A special application is the fabrication of metal tubes, especially tubes for subterranean pipelines, coated with a polyolefin protective coating, especially a polyethylene (=PE) or polypropylene (=PP) protective coating.

In the present invention, the term “metal substrate” or “metallic substrate” includes metals as such, non-metallic substrates which carry a continuous metal layer, or non-metallic substrates which are only discontinuously covered by a metallic substance, e.g. by a metal net. The metal-covered non-metallic substrate may be a part made of a plastic material, e.g. a thermoset, or a composit.

The term “non-halogenated polymer” means a polymer which is not formed by polymerizing halogen-containing monomers. Therefore, the halogen content of these non-halogenated polymers should be zero or close to zero. However, it cannot be excluded that the “non-halogenated” polymers contain some halogen-containing impurities. However, in a “non-halogenated polymer” in the sense of the present invention the halogen content should be below 1% by weight, especially below 0.1% by weight.

Throughout this specification, the terms “tube” and “pipe” can be interchanged. The term “tube” includes pipes, and the term “pipes” includes tubes.

In the production of PE- or PP-coated pipes according to the state of the art, the outer surface of a steel pipe is pretreated with a conversion coating solution, e.g. an acidic solution containing Cr(VI). Then the pipe is heated up to about 200° C. and coated with an epoxy-based primer which is usually applied as a powder coating. The primer is overcoated at about 200° C. with a hot melt adhesive onto which a PE or PP coating is applied by an extrusion process at about 200° C. After this, the pipe is cooled with water to ambient temperature. Thus, this process requires the application of two different adhesive layers between the conversion coated steel surface and the final PE or PP overcoat. In addition the process requires pipe temperatures of up to about 200° C. and is, due to the size of the pipes, energy intensive.

It is an aim of the present invention to reduce the number of process steps. It is an additional aim to reduce the total energy consumption of the process. Of course, it is expected that the performance of the pipes coated by the improved process, especially the adhesion of the PE or PP overcoat to the base metal, and the corrosion properties of the coated pipes fulfill the technical requirements for such a product.

According to the present invention, a stable one-part cationically curable composition based on epoxides is used as the adhesive to bond the polymer to the (optionally pretreated) metal surface. The composition contains a metal ion containing initiator which starts the polymerization process of the epoxy monomers, resins, or prepolymers when it comes in contact with a metallic substrate which is able to reduce the metal ion of the initiator.

RedOx cationic polymerizations involve oxidation and reduction processes. When an atom, either free or in a molecule or ion, loses an electron or electrons, it is oxidised and its oxidation number increases. When an atom, either free or in a molecule or ion, gains an electron or electrons, it is reduced and its oxidation number decreases. Oxidation and reduction always occur simultaneously, as if one atom gains electrons then another atom must provide the electrons and be oxidised. In a RedOx couple, one species acts as a reducing agent, the other as an oxidizing agent. When a RedOx reaction occurs the reducing agent gives up or donates electrons to another reactant, which it causes to be reduced. Therefore the reducing agent is itself oxidised because it has lost electrons. The oxidising agent accepts or gains electrons and causes the reducing agent to be oxidised while it is itself reduced. A comparison of the relative oxidising or reducing strengths of the two reagents in a RedOx couple permits determination of which one is the reducing agent and which one is the oxidising agent. The strength of reducing or oxidising agents can be determined from their standard reduction) (E_{red}⁰) or oxidation (Eₒₓ⁰) potentials.

Lewis acids in the form of metal salts have been used as initiators of cationic polymerization. Many strong Lewis acid initiators have been shown to function by the direct initiation of the monomer (Scheme 1) (Collomb, J.; Gandini, A.; Cheradamme, H.; Macromol. Chem. Rapid Commun. 1980, 1, 489-491). The stronger the Lewis acid the more pronounced is its initiating power.

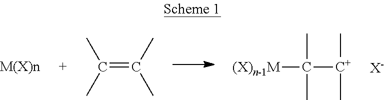

Not all Lewis acid metal salts react with cationically polymerizable monomers. Many can be formulated as the initiating component in storage stable one-component cationically polymerisable systems. In these instances decomposition of the initiator and activation of polymerization is typically achieved by thermal or electromagnetic radiation curing processes (Castell, P. et al.; Polymer 2000, 41(24), 8465-8474).

The present invention makes use of an alternative polymerization initiating process for bonding polymers to metal substrates using an epoxy-based adhesive. In this alternative process, the species starting the cationic polymerization is generated from an initiator component containing a metal ion M by a RedOx reaction of the metal ion M with a metallic surface.

One embodiment the present invention is a process of bonding a metal substrate to a non-halogenated polymer, involving the steps of
i) applying an epoxy-based adhesive to the metal or the non-halogenated polymer,
ii) mating the metal substrate and the non-halogenated polymer, and
iii) allowing the epoxy-based adhesive to cure
   wherein the epoxy-based adhesive comprises
a) one or more monomers, resins, or prepolymers with epoxy groups
b) an initiator component comprising at least one salt of a metal ion M in an oxidation state of n which has a standard reduction potential E⁰_{M} more positive than the standard reduction potential of the surface of the metal substrate, the standard reduction potential E⁰_{M} being either the standard reduction potential for the reduction of the metal ion M from its oxidation state of n to the oxidation state of zero or from its oxidation state of n to an oxidation state of m, m being smaller than n but higher than zero.

In step iii) curing can occur at temperatures of about 15° C. or above. For example, in step ii) the metal substrate and the non-halogenated polymer may be mated at ambient temperature, e.g. a temperature in the range of from about 15° C. to about 30° C., and the adhesive may be cured in step iii) at this temperature. Alternatively, the metal substrate and the non-halogenated polymer may be mated at ambient temperature, but then heated to a temperature of about 30° C. or above, e.g. in the range of 30° C. to 110° C., in order to effect the curing of the adhesive in step iii).

A special way of “mating” the metal substrate and the non-halogenated polymer is the extrusion of the non-halogenated polymer onto the metal substrate. In this process, the non-halogenated polymer has to be heated to a temperature where its viscosity is low enough for an extrusion process. This temperature may be in the range of up to 200° C. or above. The metal substrate may have a temperature below the extrusion temperature of the non-halogenated polymer. In this embodiment, the non-halogenated polymer and the metal substrate may have different temperature in step ii).

Generally speaking, the temperature of the non-halogenated polymer when it comes into contact with the epoxy-based adhesive may be between ambient temperature and the extrusion temperature if the non-halogenated polymer is, e.g., coated by extrusion onto a pipe surface carrying the epoxy-based adhesive. This temperature may be up to 200° C. or higher. If the metal pipe has a temperature below this value, especially not higher than 110° C., when the non-halogenated polymer is extruded onto it with a temperature of up to 200° C. or higher, the actual “curing temperature” of the epoxy-based adhesive will be intermediate between the pipe temperature and the extrusion temperature.

The metal substrate can be, e.g., iron or steel, galvanized or alloy galvanized steel, aluminated steel, copper or copper alloy, zinc or zinc alloy, brass, aluminum or aluminum alloy. Galvanized steel is steel coated with zinc, either electrolytically or by hot dip coating. For alloy galvanization, either zinc alloys like zinc-nickel or zinc-aluminum alloys are used for the coating, or a zinc coating is heated to a temperature where a zinc-iron alloy forms at the interface of steel and zinc.

In one embodiment, the surface of the metal substrate is pretreated by a corrosion-protective pre-treatment before the epoxy-based adhesive is applied. For example, the pre-treatment can be a cromating process involving the contact of the metal surface with an acidic solution containing Cr(VI) ions. Alternatively, the metal surface can be pretreated by contacting it with an acidic solution of fluoro complexes or Ti and/or Zr. Such pre-treatment processes are well known in the state of the art.

In a further preferred embodiment, the epoxy-based adhesive additionally comprises a corrosion inhibitor. Corrosion inhibitors (or anti-corrosion pigments) that are known for this purpose in the prior art can be employed. The following examples may be cited: magnesium oxide pigments, particularly in nanomeric form, finely divided and very finely divided barium sulfate or corrosion-protection pigments based on calcium silicate, like those known under the trade name “Shieldex™”. Metal phosphates like iron phosphates, zinc phosphates, and iron-zinc phosphates may be used as corrosion inhibitors. An especially suited corrosion inhibitor is zinc phosphate modified with zinc molybdate and organic surface treatment. The particles thereof are preferably essentially spherical and have a particle size so that at least 99.8% of the particles pass a 44 μm sieve. In addition to or instead of such inorganic corrosion inhibitors, organic corrosion inhibitors known in the state of the art may also be used.

Corrosion inhibitors are usually present in an amount of from 0.5 to 30% by weight, preferably of from 1 to 10% by weight relative to the total weight of the epoxy-based adhesive.

If the epoxy-based adhesive comprises a corrosion inhibitor, a separate conversion coating step of the metal substrate may be unnecessary, and this treatment step can be skipped, resulting in a shorter process sequence and a reduced environmental impact compared with the state of the art. Therefore, if the epoxy-based adhesive comprises a corrosion inhibitor, it is not necessary that a corrosion-protective pretreatment is applied to the surface of the metal substrate before it is contacted with the epoxy-based adhesive. However, if high corrosion resistance is required, a corrosion-protective pretreatment may be applied to the surface of the metal substrate before it is contacted with the epoxy-based adhesive, even if the adhesive comprises a corrosion inhibitor.

In general, a large number of polyepoxides having at least about two 1,2-epoxy groups per molecule are suitable as epoxy resins for the compositions used in this invention. The polyepoxides may be saturated, unsaturated, cyclic or acyclic, aliphatic, alicyclic, aromatic or heterocyclic polyepoxide compounds. Examples of suitable polyepoxides include the polyglycidyl ethers, which are prepared by reaction of epichlorohydrin or epibromohydrin with a polyphenol in the presence of alkali. Suitable polyphenols therefor are, for example, resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane, and 1,5-hydroxynaphthalene. Other suitable polyphenols as the basis for the polyglycidyl ethers are the known condensation products of phenol and formaldehyde or acetaldehyde of the novolak resin-type.

Other polyepoxides that are in principle suitable are the polyglycidyl ethers of polyalcohols or diamines. Such polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides are polyglycidyl esters of polycarboxylic acids, for example, reaction products of glycidol or epichlorohydrin with aliphatic or aromatic polycarboxylic acids, such as oxalic acid, succinic acid, glutaric acid, terephthalic acid or a dimeric fatty acid.

Other epoxides are derived from the epoxydation products of olefinically-unsaturated cycloaliphatic compounds or from natural oils and fats.

Particular preference is given to the liquid epoxy resins derived by reaction of bisphenol A or bisphenol F and epichlorohydrin. The epoxy resins that are liquid at room temperature generally have epoxy equivalent weights of from 150 to about 480.

The epoxy resins that are solid at room temperature may also or alternatively be used and are likewise obtainable from polyphenols and epichlorohydrin; particular preference is given to those based on bisphenol A or bisphenol F having a melting point of from 45 to 130° C., preferably from 50 to 80° C. They differ from the liquid epoxy resins substantially by the higher molecular weight thereof, as a result of which they become solid at room temperature. The solid epoxy resins generally have an epoxy equivalent weight of 400.

The epoxy-based adhesive preferably comprises at least a difunctional epoxy resin. It is preferably based on bisphenol A or bisphenol F. It is preferably liquid at room temperature. Epon™ 828 is an example of such a difunctional epoxy resin. In addition to the difunctional epoxy resin, a multifunctional epoxy resin may be present as well. Additionally, the epoxy-based adhesive may comprise a cycloaliphatic epoxy resin which may be difunctional or multifunctional. An example is a difunctional epoxy resin on the basis of cyclohexaneepoxide, such as epoxycyclohexanemethyl-3,4-epoxycyclohexanecarboxylate*3.4-, or 3,4-epoxycyclohexane methyl 3′,4′-epoxycyclohexylcarboxylate.

The epoxy-based adhesive may comprise about 10 to about 98 percent by weight of epoxy resin, based on the total weight of the epoxy-based adhesive. Preferably, it contains from 30 to 80 percent by weight of epoxy resins. If a mixture of aromatic and cycloaliphatic epoxy resins is used, the aromatic epoxy resin is preferably present in an amount of from 35 to 60 percent by weight, especially from 40 to 55 percent by weight. The cycloaliphatic epoxy resin is then preferably present in amount of from 10 to 20 percent by weight, all weight percents given relative to the total weight of the epoxy-based adhesive.

The metal ion M of the initiator component is selected in such a way that it is electrochemically reduced by contact with the (optionally pretreated) metal surface, either from its original oxidation state of n to an oxidation state of zero (so that any of the metal ion M that reacts is plated onto the metal surface), or from an oxidation state of n to an oxidation state of m, m being smaller than n but higher than zero, depending on the standard reduction potentials of the metal surface and the metal ion M of the initiator component. For example, M may be Ce(IV) which can be reduced to Ce(III), or Mn which can be reduced from an oxidation state of (VII) or (VI) to an oxidation state of (IV) or (II). Another potential RedOx couple for the metal ion M is Fe(III)/Fe(II), provided that the metal surface is less noble than iron.

References to standard reduction potentials in this specification indicate the tendency of a species to acquire electrons and thereby be reduced. Standard reduction potentials are measured under standard conditions: 25° C., 1 M concentration, a pressure of 1 atm and elements in their pure state.

The electrochemical series is a measure of the oxidising and reducing power of a substance based on its standard potential. The standard potential of a substance is measure relative to the hydrogen electrode. A metal with a negative standard potential has a thermodynamic tendency to reduce hydrogen ions in solution, whereas the ions of a metal with a positive standard potential have a tendency to be reduced by hydrogen gas. The reactivity series, shown in Scheme 2 (below), is an extension of the electrochemical series.

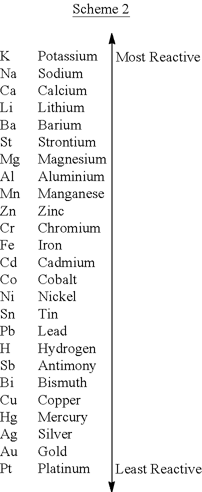

Ordinarily, only a metal or element positioned higher in the reactivity series can reduce another metal or element that is lower down in the reactivity series e.g. Iron can reduce Tin but not Potassium. It is appreciated that the order of the reactivity series can be (changed) inverted from that shown in Scheme 2. The terms “higher” and “lower” will be understood however as referring to a reactivity series having at the most reactive at the top and the least reactive at the bottom in the sequence shown in Scheme 2. In any event in the context of the present invention it will be appreciated that the metal of the initiator component is chosen so that it is reducible at the surface to which it is applied.

The initiator may be selected from the compounds disclosed in DE 10 2006 057 142, as long as the RedOx-potential of the metal ion M fulfills the criteria defined above.

The initiator component may be added to the epoxy-based adhesive formulation as such. However, it is also possible to add precursors of the initiator component, so that the initiator component itself is formed within the epoxy-based adhesive formulation. For example, instead of the initiator component AgSbF₆ it is possible to add the salts AgNO₃ and Na- or KSbF₆ to the adhesive formulation. If it is intended to use an initiator component where the metal ion M is bonded to an organic ligand, it is possible to add the metal salt like AgSbF₆ and the ligand separately to the adhesive formulation.

Preferably, the initiator component of the composition comprises a transition metal cation, so that it is a transition metal salt. The metal ion may be not bonded to an organic ligand, but it may also be substituted with a ligand. If the metal ion M is part of an organic complex, i.e. if the metal ion M is bonded to at least one organic ligand, a ligand is preferred which has one or more C═C double bonds, the binding site of the metal to the organic ligand being one ore more C═C double bonds. Examples of such ligands are: open-chain or cyclic monoolefins, dienes or trienes like cyclohexene, cyclododecene, hexadiene, decadiene, e.g. 1,9-decadiene, octadiene, e.g. 1,7-octadiene, cyclooctadiene, e.g. 1,5-cyclooctadiene, and the like. However, crown ethers or open-chain ethers with two or more ether linkages can also be present as ligands. Preferred crown ethers are dibenzo-18-crown-5, and crown ethers lager than this one. Preferred open-chain ethers with two or more ether linkages are diethylenglykoldivinylether, triethylenglycoldivinylether, and butandioldivinylether which are also mentioned further below as possible accelerators.

Independent from the fact whether the metal M is bonded to an organic ligand or not, the metal salt counterions may preferably be chosen from anions of strong inorganic or organic acids. A strong acid is defined as an acid having a pK_{S} value of below 0. Examples of strong organic acids may be chosen from the so-called “superacids”. Anions of strong inorganic acids may be chosen, e.g., from the group consisting of ClO₄⁻, BF₄⁻, PF₆⁻, SbF₆⁻, AsF₆⁻, (C₆F₆)₄B anion, (C₆F₆)₄Ga anion, Carborane anion, triflimide (trifluoromethanesulfonate) anion, bis-triflimide anion, anions based thereon and combinations thereof. Further desirably, the metal salt counterions may be chosen from the group consisting of ClO₄⁻, BF₄⁻, PF₆⁻, SbF₆⁻ and combinations thereof. SbF₆⁻ is especially preferred for solubility and stability reasons.

Preferred metal ions M include silver, copper and combinations thereof, especially if the metal substrate consists of iron or steel. Their counterions are preferably chosen from the group consisting of ClO₄⁻, BF₄⁻, PF₆⁻, SbF₆⁻ and combinations thereof. SbF₆⁻ is especially preferred. Examples of initiators are: Ag(BF₄), Ag(PF₆), Ag(trifluoromethanesulfonate), Cu(BF₄)₂, Zn(BF₄)₂.

The most preferred initiator component is AgSbF₆, especially if the metal substrate is steel (which may be conversion coated as described above). However, especially for solubility reasons, Ag(Ligand)ₙSbF₆, wherein the Ligand is preferably selected from the group consisting of crown ethers, or of open-chain or cyclic monoolefins, dienes or trienes like cyclohexene, cyclododecene, hexadiene, decadiene, e.g. 1,9-decadiene, octadiene, e.g. 1,7-octadiene, cyclooctadiene, e.g. 1,5-cyclooctadiene, may be another preferred initiator component. The number n of the Ligand(s) may be 1 or, usually, 2. The Ligand may also bridge two metal ions M in a way that dimers, oligomers, or polymers are formed. Of course, also the other copper or silver salts mentioned in the preceding paragraph may carry such ligands on the metal ion.

The solubility of the metal salt may be modified by changing the counterion, the addition and/or substitution of ligands to the metal of the metal salt and combinations thereof. This will allow for efficient electron transfer between the surface and the metal salt to be observed as appropriate solubility is achieved.

The initiator component containing the metal ion M is usually present in an amount of 0.1 to 10 percent by weight, preferably in an amount of from 0.3 to 7 percent by weight relative to the total weight of the epoxy-based adhesive. If, e.g., AgSbF₆ is used as the initiator component, it may be present in an amount of from 0.3 to 3 percent by weight. If Ag(Cylooctadiene)₂SbF₆ with a higher molecular weight is used as the initiator component, it is preferably present in an amount of from 1.5 to 5 percent by weight. If the analogues copper compounds are used, their preferred ranges can be calculated using the molecular weight ratios of the Ag and Cu compounds.

In general, the adhesive compositions used herein can cure on oxidised metal surfaces without the need for additional etchant or oxide remover. However, the compositions used for the invention may optionally include an oxide remover. For example, including an etchant or oxide remover, such as those comprising chloride ions and/or a zinc (II) salt, in formulations for the invention allows etching of any oxide layer. This will in turn expose the (zero-oxidation state) metal below, which is then sufficiently active to allow reduction of the transition metal salt.

The RedOx cationic systems used herein do not require any additional reducing agent. They are stable until applied to a metal substrate which is capable of participating in a RedOx reaction, thus fulfilling the role of a conventional reducing agent component. The compositions used in the invention are storage stable even as a one-part composition and require no special packaging.

The compositions used in the present invention do not require an additional catalyst for efficient curing. The present invention utilizes appropriate selection of the initiator component relative to the metal surface on which the composition is to be applied and cured. Thus surface promoted RedOx chemistry can be utilized to initiate cure in cationically curable epoxy compositions. However, it will be appreciated that compositions used in the invention may optionally comprise a catalyst to effect electron transfer between the metal surface and the initiator component of the composition. This may be useful where even greater cure speeds are required. Suitable catalysts include transition metal salts. A catalyst accelerates the curing reaction without being consumed. This differentiates a catalyst from a curing accelerator which is described in the subsequent paragraphs and which is consumed during the curing reaction.

In a preferred embodiment, the epoxy-based adhesive additionally comprises a curing accelerator, preferably a species comprising at least one vinyl ether functional group. The accelerator species comprising at least one vinyl ether functional group greatly enhances the rate of cure. The accelerator species may embrace the following structures:

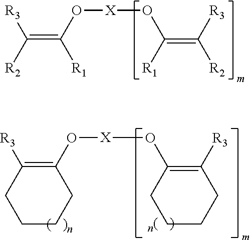

wherein m can be 0 or 1;
n can be 0-5;
R₁, R₂, and R₃ can be the same or different and can be selected from the group consisting of hydrogen, C₁-C₂₀ alkyl chain (linear, branched or cyclic) and C₅-C₂₀ aryl moiety, and combinations thereof;
X can be a C₁-C₃₀ saturated or unsaturated, cyclic or acyclic moiety; and
   R₁, R₂, R₃ and X may or may not independently contain ether linkages, sulfur linkages, carboxyl groups, and carbonyl groups.

It will be appreciated by a person skilled in the art that X, R₁, R₂, and R₃ in the above formulae may comprise substituted variants and derivatives thereof, e.g. halogen substituted, heteroatom substituted, etc., without substantially altering the function of the molecules.

Desirably, the vinyl ether component is selected from the group consisting of 1,4-butanediol divinyl ether, 1,4-butanediol vinyl ether, bis-(4-vinyl oxy butyl) adipate, ethyl-1-propenyl ether, bis-(4-vinyl oxy butyl) isophthalate, bis[4-(vinyloxy)butyl] succinate, bis[4-(vinyloxy)butyl] terephthalate, bis[[4-[(vinyloxy)methyl]cyclohexyl]-methyl] isophthalate, bis[[4-[(vinyloxy)methyl]cyclohexyl]methyl] glutarate, tris(4-vinyloxybutyl)trimellitate, Vectomer™ 2020 (CAS no. 143477-70-7), 2-ethylhexylvinylether, 4-hydroxybutylvinylether, cyclohexylvinylether, diethylenglykoldivinylether, dodeclyvinylether, ethylvinylether, isobutylvinylether, n-butylvinylether, tert.-butylvinylether, octadecylvinylether, triethylenglykoldivinylether, poly-THF-divinylether, polyglycol-based monovinylether, cyclohexanedimethanol-divinylether, cyclohexanedimethanol-monovinylether, and combinations thereof. Preferred vinyl ethers are diethylenglykoldivinylether, triethylenglycoldivinylether, and butandioldivinylether.

The vinyl ether component may have complexing properties for the metal ion M of the initiator component, so that it is also a complexing agent, and can improve the solubility thereof in the epoxy-based adhesive.

The accelerator component or complexing agent comprising the at least one vinyl ether functional group greatly accelerates the rate of cationic polymerization. The accelerator component may be present in an amount up to 60% w/w of the total composition, for example 5-50% w/w of the total composition, desirably from 5 to 20% w/w of the total composition.

In addition, the epoxy-based adhesive may additionally comprise particles with an average particle size below 1 μm (as determined by electronic microscopy) different from corrosion inhibitor particles as described further above. Such additional particles may act, e.g. as rheology modifier. Examples of such particles are the various forms of precipitated or fumed silica. Their particle size (measured for the aggregates by electronic microscopy) is usually below 0.5 μm, but above 0.1 μm.

These particles are usually present in an amount of from 0.5 to 20% by weight, preferably of from 1 to 10% by weight relative to the total weight of the epoxy-based adhesive.

The epoxy-based adhesive may comprise further constituents. Examples are:
Additional solubilizer for the initiator component, e.g. crown ethers: 0 to 10 percent by weight, preferably 0.3 to 7 percent by weight;
Fillers (other than corrosion inhibitors and rheology modifiers): 0 to 70 percent by weight, preferably 1 to 50 percent by weight;
Flexibilizers, e.g. additional epoxy-polymers based on amino-terminated polyether, epoxy-based (reactive) rubbers, or polymers different from epoxy resins, e.g. thermoplastic polyurethanes or rubbers like polymers or copolymers of butadiene and/or isoprene: 0 to 60 percent by weight, preferably 2 to 50 percent by weight. In addition to, or instead of these reactive flexibilizing agents, it can be particularly advantageous to include or more rubbers in the epoxy-based adhesive composition, as such additives will toughen the cured adhesive and reduce the tendency of the cured adhesive to crack under stress. As used herein, the term “rubbers” includes both rubbers and elastomers. Suitable rubbers include thermoplastic rubbers. Illustrative types of rubber include styrene-butadiene rubbers (SBR), butyl rubbers, polyisoprene, natural rubber, polybutadiene, isobutylene polymers, alpha-olefin elastomers, ethylene-propylene elastomers, ethylene-propylene-diene (EPDM) rubbers, ethylene-vinyl acetate rubbers, hydrogenated natural rubbers, and the like. Thermoplastic block copolymers are one particularly preferred class of rubbers for use in the present invention. Such materials contain one or more base segments (“A”) covalently bonded to one or more soft or elastomeric segments (“B”). The A segments may be polystyrene, poly (alpha-methylstyrene), polyethylene, polyurethane, polysulfone, polyester, polycarbonate or the like. The B segments may be polybutadiene, polyisoprene, poly (ethylene-co butylene), polydimethylsiloxane, polyether, or the like. The block copolymers may have a linear, branched, radial or star structure and may, for example, correspond to the general structure A-B-A, (A-B)ₙ, and so forth. SIS, SEBS and SBS block copolymers are examples of specific types of such materials. Liquid rubbers such as butadiene-copolymers, which may be functionalized with carboxy groups or other groups capable of reacting with other components of the epoxy-based adhesive composition, may also be employed.

Using the epoxy-based adhesive as described above, a non-halogenated polymeric material such as polyolefins can be bonded to a metal substrate without the necessity of activating the surface of the non-halogenated polymeric material. As known in the state of the art, the bonding of polymers, especially polyolefins, usually requires a surface activation, e.g. by treatment with strong oxidants, by flame treatment or by plasma treatment. These process steps are not necessary for the process according to the present invention. Therefore, in one embodiment the inventive process is characterized by the fact that the non-halogenated polymer substrate is not physically or chemically activated before being contacted with the epoxy-based adhesive.

The non-halogenated polymer substrate to be bonded to the metal substrate may be selected from the group consisting of polyolefins, preferably polyethylene or polypropylene, polycarbonates, polyamides like nylon, polyethers, and polyesters, e.g. polyalkylene terephthalate. Especially important polyolefins are polyethylene (PE) and polypropylene (PP) which are used as outer coatings for the tubes of subterranean or surface pipelines.

The epoxy-based adhesive may be applied onto the metallic or non-halogenated polymer substrate, especially onto the surface of a tube or pipe, as a liquid (at ambient temperature or at an elevated temperature below the curing temperature), or in powder form. As a liquid, it may be brushed or sprayed onto the substrate. Smaller pieces may also be dipped into the epoxy-based adhesive, with subsequent removal of excess adhesive. The epoxy-based adhesive may also be sprayed as a powder onto the substrate, e.g. in an electrostatic spray process, and then melted by increasing the temperature of the substrate. As an alternative, the substrate may be pre-heated above the melting temperature of the powder (but below its curing temperature), and the powder may be sprayed with ambient temperature onto the pre-heated substrate, so that it sticks to the surface by at least partial melting.

One special aim of the present invention is to provide an improved process for the bonding of the PE or PP coating of a tube to the (outer or inner) metal surface of the tube, which is usually a steel surface. Therefore, in a special embodiment of the present invention the metal substrate is a tube, and in step i) the epoxy-based adhesive is applied to the outer tube surface, and in step ii) the polymer is coated onto the epoxy-adhesive layer by extrusion.

Before the epoxy-based adhesive is applied to the outer or inner tube surface in step i), the tube does not need to be heated up at all, but it may also be heated up, e.g. to a temperature of at least 60° C., but usually not more than 110° C., especially not more than 150° C. Heating the tube to higher temperatures is not necessary (unlike the state of the art). In step ii) the polymer, especially a PE- or PP-substrate is extruded with a temperature of more than 200° C. onto the outer or inner tube surface which may or may not have been pre-heated in connection with step i). The coating speed may be in the range of 6 m/min. The coated tube may be cooled to ambient temperature with water.

Typically, after curing the epoxy-based adhesive has a thickness of about 1 to 500 μm. The thickness of the polymeric overcoat (e.g. a PE or PP layer) is usually in the range of 0.2 to 10 mm.

According to this process, there is just one adhesive layer between the surface of the metal substrate (which may be conversion coated) and the polymeric overcoat. It is not necessary to apply an additional primer, which saves material and leads to a more economic process. In certain embodiments described further above, it is unnecessary to conversion coat the metallic substrate before the adhesive is applied. This also shortens up the process sequence, reduces the amount of chemicals consumed, and the amount of waste generated. It is especially important that in these embodiments it is unnecessary to use toxic and carcinogenic Cr(VI) compounds for conversion coating,

Thus, compared to the state of the art for pipe coating, the inventive process reduces the number of process steps and allows lowering the temperature of the metallic substrate. This leads to significant energy savings, especially if the size of tubes used for long-distance pipe lines is taken into account. This has considerable economic and ecologic advantages. If the tubes are not heated up at all, there is no need for oven space any more.

Another aspect of the invention is an object comprising a metal substrate and a non-halogenated polymer which have been bonded together by a process according to this invention. A special object according to this invention is a tube made of a metal substrate onto which a coating of a non-halogenated polymer, especially a PE- or PP-coating is bonded by a cured epoxy-based adhesive, which is preferably the only adhesive to bond the polymeric coating to the metal surface. The epoxy-based adhesive may be one which is used in the process of the present invention. The inventive tubes may be especially used for subterranean pipelines. Of course, they may be used for surface pipelines as well.

Finally, the present invention comprises a tube made of a metal substrate which has been coated with a non-halogenated polymer, especially a PE- or PP-substrate, according to the process of this invention.

### EXAMPLES

Epoxy-based adhesives which can be used in the process of the present invention have been prepared by mixing the components according to the following table. Example 4 is a reference where no metal-containing initiator has been used. This adhesive is not able to bond polyolefins to metals.

In peel tests using cold rolled steel (CRS) as the metallic substrate and cross-linked PE as the polymer, failure of the PE layer is observed. This means that the cohesive strength of the adhesive layer and the adhesive strength between this layer and the PE-layer is stronger than the PE-layer itself.

Compositions (in percent by weight relative to the total composition). Example 4 (without initiator) is a reference example:

| | 1 | 2 | 3 | 4 (Ref) | 5 | 6 |
|---|---|---|---|---|---|---|
| Bisphenol A Epoxy Resin | 47.7% | 46.9% | 62.5% | 48.0% | 53.3% | 54.8% |
| (Epon ™ 828) | | | | | | |
| Cycloaliphatic Epoxy Resin | 15.9% | 15.6% | | 16.0% | | |
| (Cyracure ™ UV6110)¹⁾ | | | | | | |
| Accelerator or Complexing | 15.9% | 15.6% | 15.6% | 16.0% | 26.7% | 27.4% |
| Agent²⁾ | | | | | | |
| Initiator 1 | 0.6% | | | | | 0.7% |
| (AgSbF₆) | | | | | | |
| Initiator 2 | | 2.3% | 2.3% | | 3.3% | |
| (Ag(COD)ₙSbF₆)³⁾ | | | | | | |
| Corrosion Inhibitor⁴⁾ | 15.9% | 15.6% | 15.6% | 16.0% | 13.3% | 13.7% |
| Fumed Silica | 4.0% | 3.9% | 3.9% | 4.0% | 3.3% | 3.4% |
| (CabOsil ™ TS720) | | | | | | |
| Total | 100.0% | 100.0% | 100.0% | 100.0% | 100.0% | 100.0% |
| Results 45° Peel Test | PE | PE | PE | No | PE | PE |
| 200 μm bondline | failure | failure | failure | bonding | failure | peeled |
| Grid blasted CRS (1, 5 mm) | | | | | | 6 N/mm |
| Cross-linked PE (0, 8 mm) | | | | | | (solubility |
| | | | | | | issue) |

¹⁾Epoxycyclohexanemethyl-3,4-epoxycyclohexanecarboxylate*3.4-
²⁾Triethyleneglycol divinyl ether (=1,6,9,12-tetraoxatetradeca-1,13-diene)
³⁾COD = 1,5-cyclooctadiene; n generally equal to 2
⁴⁾Zinc phosphate modified with zinc molybdate and organic surface treatment. The particles are essentially spherical and have a particle size so that at least 99.8 % of the particles pass a 44 μm sieve

1. A process of bonding a metal substrate to a non-halogenated polymer, involving the steps of
i) applying an epoxy-based adhesive to the metal or the non-halogenated polymer,
ii) mating the metal substrate and the non-halogenated polymer, and
iii) allowing the epoxy-based adhesive to cure,
wherein the epoxy-based adhesive comprises
a) one or more monomers, resins or prepolymers with epoxy groups
b) an initiator component comprising at least one salt of a metal ion M in an oxidation state of n which has a standard reduction potential E⁰_{M} more positive than the standard reduction potential of the surface of the metal substrate, the standard reduction potential E⁰_{M} being either the standard reduction potential for the reduction of the metal ion M from its oxidation state of n to the oxidation state of zero or from its oxidation state of n to an oxidation state of m, m being smaller than n but higher than zero.

2-15. (canceled)
